(19) United States
(12) Patent Application Publication
(10) Pub. No.: US 2018/0318947 A1
(43) Pub. Date: Nov. 8, 2018

(54) METAL LAPPING COMPOUND FOR THE LAPPING OF GEARS

(71) Applicant: Klingelnberg AG, Zurich (CH)

(72) Inventors: Hastings Wyman, Saline, MI (US); Hartmuth Müller, Remscheid (DE)

(21) Appl. No.: 15/968,888

(22) Filed: May 2, 2018

(30) Foreign Application Priority Data
May 4, 2017 (EP) 17169378.1

(51) Int. Cl. B23F 19/02; C09G 1/02; B24B 37/04

(52) U.S. Cl. CPC B23F 19/02; B24B 37/044; C09G 1/02

(57) ABSTRACT

A metal lapping compound (20) for specific use in an apparatus (100) for the lapping of gears (T, R), having a fluid system (30) for supplying the metal lapping compound (20) into an area (aB) where, during a lapping operation, a first gear (T) engages with a counterpart (R), and further having a sensing system (40) for determining optic and/or electric and/or magnetic properties of the metal lapping compound (20). The lapping compound (20) has at least an oil portion as fluid carrier, an abrasive portion, and a polar portion, altogether providing for an ion-containing liquid.

### CROSS REFERENCE TO RELATED APPLICATIONS

This application claims priority under 35 U.S.C. §§ 119(a)-(d) to European patent application no. EP 17 169 378.1 filed May 4, 2017, which is hereby expressly incorporated by reference as part of the present disclosure.

### FIELD OF THE INVENTION

The present disclosure generally relates to a specific metal lapping compound for use in a lapping apparatus.

### BACKGROUND

There are various approaches for the fine machining of gears. The gear lapping method is widely used for the purposes of hard finishing of gears.

In a respective lapping machine, at least one gear is rotated (called engagement rotation) and put in engagement with another gear or tool (herein referred to as counterpart). A lapping compound (e.g. an oil with silicon carbide) is introduced into the active area of the lapping machine in order to provide an abrasive component in-between the meshing flanks of the gear and the counterpart.

In order to be able to carry out a lapping operation on bevel gears, typically, in addition to the engagement rotation, one or more relative displacement movements (herein called additional movements) are applied.

Lapping is a method which is, for instance, used for the final processing (finishing processing after the quenching) of the tooth flanks of bevel gear pairs (bevel gear trains). After a crown gear is mounted on a first spindle and a pinion, which is to be paired therewith, is mounted on a second spindle, typically the pinion is caused to rotate while the crown gear being engaged with the pinion runs along or is slowed down. The lapping compound is employed as grinding means while the two wheels are carrying out a continuous engagement rotation. During the lapping, additional movement(s) is/are carried out in order to extend the lapping action to the total tooth flank surface of the two wheels.

Machines are being offered by the producers of lapping machines which differ from each other essentially by differently designed axial constellations. Most lapping machines are able to carry out three linear movements, whereby two horizontal movements are required, since, otherwise, a shifting of the pinion would quickly use up the backlash and thus result in a clamping if the crown gear is not moved alongside correspondingly. A vertical axis is required for the lapping of hypoid gears in order to adjust the axial offset, and it can be used to displace the bearing pattern during the lapping.

Most widely used for gear lapping are lapping compounds which comprise an oil portion as a fluid carrier and an abrasive portion. Corundum is often used as abrasive portion, since this material has a superior hardness (about 9.0 on the Mohs scale). It is, however, a problem of previously-known lapping compounds that, on the one hand, the abrasiveness of the abrasive particles deteriorates (e.g. due to abrasive wear), and, on the other hand, the lapping compound carries more and more metal chips and metal particles the longer the compound is being used. There is another issue which needs to be addressed when using lapping compounds in a lapping machine. The abrasive portion has the tendency to settle in the reservoir if the lapping compound is not used. Fluid systems which are designed for supplying a constant quality lapping compound to the lapping machine's active area thus comprise an agitator, stirrer or bubbler in order to ensure that a homogeneous mixture is provided at all times.

In order to deal with the metal chips and particles inside the lapping compound, the fluid system might comprise a magnet. This magnet attracts the metal and keeps the total volume of the lapping compound clean. Such a magnet has to be removed from the fluid system in order to remove the metal which has gathered over time.

High performance lapping compounds are getting more and more expensive as their characteristic properties are developed further. In addition, the environmental and work safety regulations and laws are getting more and more rigorous.

### SUMMARY

It is therefore an object to develop a lapping compound which ensures a constant quality, as far as the abrasiveness of the abrasive portion and the homogeneity of the overall lapping compound are concerned.

It is a further object to develop a suitable lapping compound.

In accordance with one aspect, such metal lapping compound is for lapping gears in an apparatus that includes a fluid system for supplying the lapping compound into an area where a first gear engages with a counterpart during lapping, and a sensing system for determining one or more of optic, electric, or magnetic properties of the lapping compound. The lapping compound includes an oil portion as fluid carrier, an abrasive portion, and a polar portion, together forming an ionic liquid.

In some embodiments, the metal lapping compound is a conductive non-aqueous electrolytic liquid. The polar portion of the lapping compound may include ammonia (NH₃), acetic acid (CH₃CO₂H), carbonic acid (H₂CO₃), and/or phosphoric acid (H₃PO₄). The lapping compound may be partially ionized, e.g., with a ratio of ionization in the range between about 0.5% and about 20%. In some embodiments, the oil portion of the lapping compound includes a low viscosity hydrocarbon. The abrasive portion of the lapping compound may include metal oxide, a carbide, cubic boron nitride (CBN), diamond bort, garnet, and/or bentonite. In some embodiments, the lapping compound includes or forms an oil miscible fluid. The lapping compound may have lubricating, lapping and/or cooling properties, as well as properties of an electrolyte.

According to one aspect, a metal lapping compound for use in an apparatus for the lapping of gears is provided, where the apparatus comprises a fluid system for supplying the metal lapping compound into an area where during a lapping operation a first gear engages with a counterpart, and which at least comprises
an oil portion as fluid carrier,
an abrasive portion, and
a polar portion,

altogether providing for an ion comprising liquid.

The respective metal lapping compound is well-suited for use in an apparatus for the lapping of gears. The apparatus comprises a first spindle group for chucking a first gear, whereby the first gear is mountable on the first spindle group so that it is rotatable about a first axis of rotation,

a second spindle group for chucking a counterpart, whereby the counterpart is mountable on the second spindle group so that it is rotatable about a second axis of rotation,

at least one spindle drive for rotating the first spindle group or the second spindle group,

multiple additional axes enabling the first gear to be engaged with the counterpart in order to perform a lapping operation during which the first gear rotates or is rotated about the first axis of rotation and the counterpart rotates or is rotated about the second axis of rotation,

a fluid system for supplying a lapping compound into an area where during the lapping operation the first gear engages with the counterpart,

wherein in that the apparatus further comprises:

a sensing system for determining optic and/or electric and/or magnetic properties of the lapping compound.

The apparatus is working reliably if the metal lapping compound is a conductive non-aqueous electrolytic liquid or the lapping compound is partially ionized, with a ratio of ionization in the range between about 0.5% and about 20%.

In addition, the removal or inactivation of the metal chips and metal particles is addressed, since this is a pre-condition for a reliable detection of the lapping compound's state.

The metal lapping compound enhances the uptime of the lapping apparatus and it reduces the maintenance expenditures since the intervention of an operator is rarely necessary.

Other objects, features, and/or advantages will become apparent in view of the following detailed description of the embodiments and the accompanying drawings.

However, while various objects, features and/or advantages have been described in this summary and/or will become more readily apparent in view of the following detailed description and accompanying drawings, it should be understood that such objects, features and/or advantages are not required in all aspects and embodiments.

This summary is not exhaustive of the scope of the present aspects and embodiments. Thus, while certain aspects and embodiments have been presented and/or outlined in this summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Other advantages and features will become apparent from the following detailed description, which is to be understood not to be limiting and which will be described in greater detail hereafter with reference to the drawings, wherein:

FIG. 1 shows a schematic top view of a lapping machine comprising a fluid system and a metal lapping compound;

FIG. 2A shows a schematic section of a pipe or hose with a “window” for illustrative purposes only to show the current composition of the lapping compound, which in this example is carrying only abrasive particles, flowing through the pipe or hose;

FIG. 2B shows the pipe or hose of FIG. 2A, where the lapping compound in the present example carries worn out abrasive particles plus metal chips or particles;

FIG. 3A is a schematic diagram of a first embodiment of a fluid system comprising a sensing system;

FIG. 3B is a schematic diagram of a second embodiment of a fluid system comprising a sensing system;

FIG. 3C is a schematic diagram of a third embodiment of a fluid system comprising a sensing system;

FIG. 4A is a schematic diagram of a first embodiment of a sensing system;

FIG. 4B is a schematic diagram of a second embodiment of a sensing system;

FIG. 5 is a schematic graph showing two absorption spectra as a function of the wavenumber;

FIG. 6 is a schematic diagram of a signal processing apparatus connected to a computer;

FIG. 7 is a schematic diagram of another embodiment of a sensing system.

### DETAILED DESCRIPTION

In connection with the present description, terms are used which also find use in relevant publications and patents. It is noted however, that the use of these terms shall merely serve a better comprehension. The inventive idea and the scope of the patent claims shall not be limited in their interpretation by the specific selection of the terms. The invention can be transferred to or used with other systems of terminology and/or technical areas. In other technical areas, the terms are to be employed analogously.

Lapping is herein referred to as meshing rotation of two gear elements (e.g. a crown gear T and a pinion R), or of a gear wheel and a lapping tool, with each other, whereby a contact is caused between the tooth flanks and where a lapping compound 20 is introduced in order to cause metal removal at least on one of the gear elements T or R.

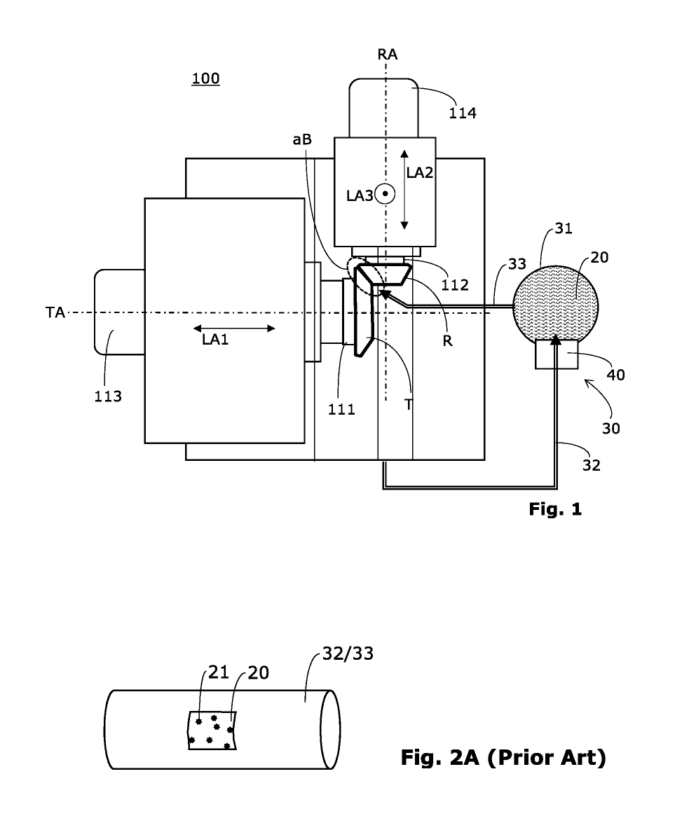

An exemplary lapping apparatus 100 is shown in FIG. 1. This apparatus 100 comprises a first spindle group 111 for chucking a first gear T. This first gear T is mountable on the first spindle group 111 so that it is rotatable about a first axis of rotation TA. The apparatus 100 further comprises a second spindle group 112 for chucking a counterpart R, whereby this counterpart R is mountable on the second spindle group 112 so that it is rotatable about a second axis of rotation RA. At least a first spindle drive 113 or a second spindle drive 114 is provided. At least one of the first spindle drive 113 and the second spindle drive 114 is provided for rotating the first spindle group 111 and/or the second spindle group 112.

A number of different embodiments are possible where either the first gear T is caused to rotate and where the counterpart R is rotating with the first gear T since it meshes therewith. Vice versa, the counterpart R is caused to rotate and the first gear T is rotating with the counterpart R since it meshes therewith. It is also possible to actively drive both the first gear T and the counterpart R or to drive only one of these two and to apply a braking force to the other.

The apparatus 100 further comprises multiple additional axes LA1, LA2, LA3 (e.g. multiple additional axial movement mechanisms) enabling the first gear T to be engaged with the counterpart R in order to perform a lapping operation. The example of FIG. 1 shows three linear axes LA1, LA2 and LA3. This specific arrangement, however, is an example only.

There is a fluid system 30 for supplying the lapping compound 20 into an area (herein referred to as active area aB) where during the lapping operation the first gear T engages with the counterpart R. The active area aB is in FIG. 1 indicated by a dashed oval.

The fluid system 30 is schematically illustrated in FIG. 1. It comprises in some embodiments an open or closed reservoir 31 containing the lapping compound 20. There are pipes and/or hoses 32 and 33 which provide for a circulation of the lapping compound 20.

The fluid system 30 or the apparatus 100 of some embodiments further comprises a sensing system 40 for determining optical and/or electric and/or magnetic properties of the lapping compound 20. In FIG. 1, this sensing system 40 is depicted as a white box which is located at the downstream end of the pipe or hose 32.

The means for re-filling or replacing of the lapping compound 20 and the means for bringing (e.g. by spraying or pouring) the lapping compound 20 into the active area aB are not shown in the figures since such solutions are well known to a person skilled in the art.

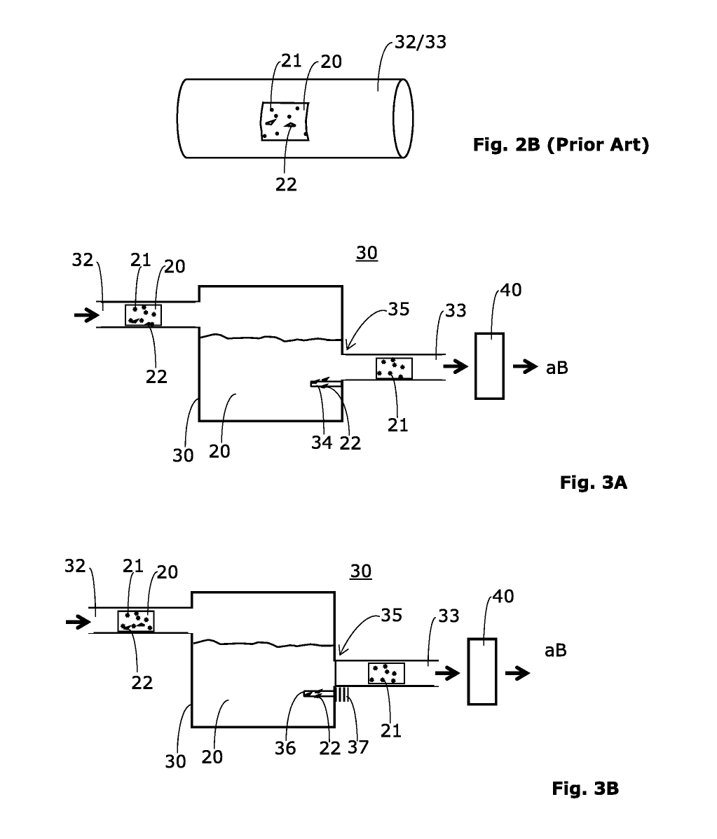

FIG. 2A shows a schematic view of a short section of a pipe or hose 32, 33. In order to be able to show the lapping compound 20 flowing through this pipe or hose 32, 33, a small window is provided. In FIG. 2A, the abrasive particles 21 are illustrated by small star-shaped elements. New abrasive particles 21 and particles which are not worn out have a rough, uneven, or coarse surface. The surface properties or characteristics of the abrasive particles 21 are mainly determined by its crystal structure, if one of the following abrasive materials are used:

a metal oxide, e.g. Al₂O₃ (called Corundum), and/or

a carbide, e.g. silicon carbide (SiC) or silica or boron carbide, and/or

boron nitride (e.g., CBN), and/or

diamond bort.

FIG. 2B shows the pipe or hose 32, 33 of FIG. 2A. In this case, however, a lapping compound 20 with worn-out abrasive particles 21 is shown. The worn-out abrasive particles 21 are symbolized by small circular elements. In addition, the lapping compound 20 of FIG. 2B carries metal chips and particles 22. These particles are symbolized by angular elements. The respective lapping compound 20 should not be used for lapping purposes anymore since its abrasiveness is reduced and since it is overloaded with metal chips and particles 22.

In the following, several approaches are described by means of which the sensing system 40 is able to determine the current properties of the lapping compound 20. This is essential, since without the capability to determine the current properties, it is not possible to automate the handling of the lapping compound 20.

If the lapping compound 20 is loaded with abrasive particles 21 and with metal chips and metal particles 22, it is difficult to determine the current properties of the lapping compound 20 as such. There are too many different effects which can interfere with each other.

It is thus possible to use means for holding back the metal chips and particles 22, at least until the sensing system 40 has carried out a measurement of the abrasive particles 21.

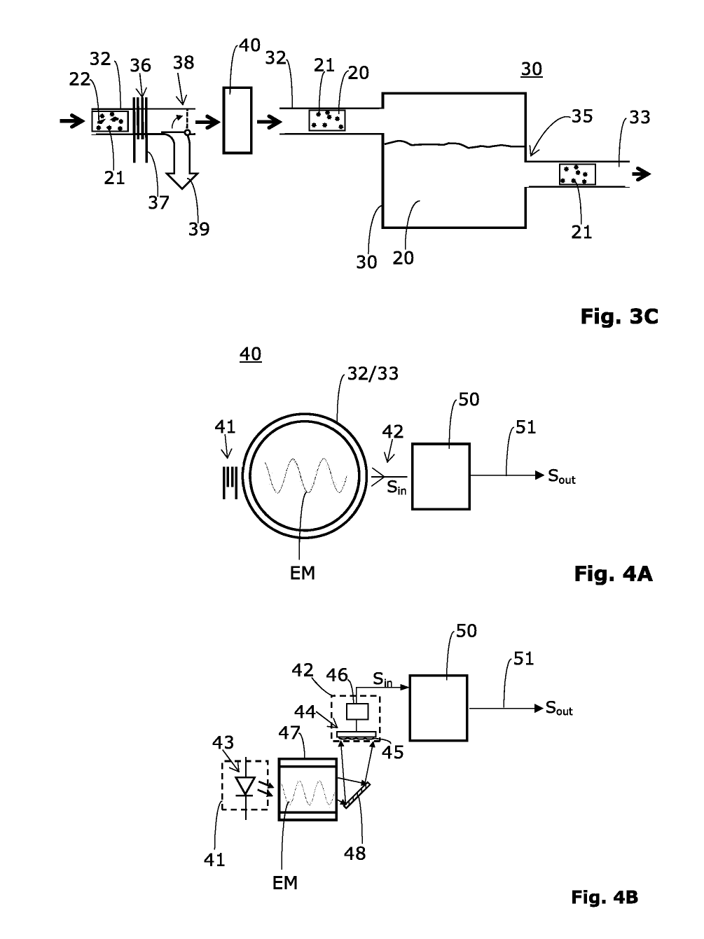

This can be achieved by any suitable solutions, the following being only some examples:
A1. a permanent magnet 34 inside or at the reservoir 31 which is strong enough to hold back or retain all metal chips and particles 22 for a given period of time (e.g., as schematically illustrated in FIG. 3A);
A2. an electromagnet 36 inside or at the reservoir 31 which is strong enough to hold back or retain all metal chips and particles 22 for a given period of time (e.g., as schematically illustrated in FIG. 3B); or
A3. an electromagnet inside or at the pipe or hose 32, 33 which can be activated before the sensing system 40 carries out a measurement (e.g., as schematically illustrated in FIG. 3C).

The basic principle of the approach A1 is schematically illustrated in FIG. 3A. A pipe or hose 32 is collecting the lapping compound 20, after it has been used in an apparatus 100 (e.g. in the apparatus 100 of FIG. 1), for feeding the lapping compound 20 into the reservoir 30. The lapping compound 20 is carrying abrasive particles 21 which are not worn out and it is carrying metal chips and metal particles 22. The reservoir 30 is equipped with a permanent magnet 34 which is here located near a port or tap 35 where fresh lapping compound 20 is pumped towards the active area aB of the apparatus 100. The permanent magnet 34 is holding back metal chips and particles 22 so that the lapping compound 20 which is flowing through the pipe or hose 33 is generally free of metal chips and particles 22.

In the embodiment depicted in FIG. 3A, the sensing system 40 is located at the pipe or hose 33 which is connecting the reservoir 30 with the active area aB of the apparatus 100. In FIG. 3A, a white block is used to symbolize the sensing system 40. The lapping compound 20 is flowing through this sensing system 40. Since the lapping compound 20 is completely or almost free of any metal chips and particles 22, the measurement can be carried out without disturbances.

The permanent magnet 34 is designed so that it can be removed from the reservoir 30 for cleaning purposes. If the cleaning of the permanent magnet 34 is carried out in regular intervals, the permanent magnet 34 will continue to magnetically attract metal chips and particles 22.

Another arrangement is shown in FIG. 3B. FIG. 3B shows an implementation of the approach A2. An electromagnet 36 can be placed in or at the reservoir 30. In order to illustrate that the electromagnet 36 can be switched on and off, a coil 37 is shown. During a cleaning procedure, the electromagnet 36 can be removed from the reservoir. The metal chips and particles 22 can be separated from the electromagnet 36 after it has been switched off. Other aspects/elements of this embodiment are similar to FIG. 3A.

Yet another arrangement is shown in FIG. 3C. FIG. 3C shows an implementation of the approach A3. If an electromagnet 36 is used, it is possible to implement a process for the automated removal of metal chips and particles 22, as will be explained in connection with FIG. 3C. The embodiment of FIG. 3C comprises a sensing system 40 which is situated at the input side of reservoir 30, for instance. On the left hand side of FIG. 3C one can see that the lapping compound 20 is carrying non worn-out abrasive particles 21 as well as metal chips and particles 22. There is an electromagnet 36 placed at the pipe or hose 32. The electromagnet 36 is here illustrated by a coil 37 which is wound around the outside of the pipe or hose 32. Downstream of this electromagnet 36 there is a fluid valve or switch 38. This valve or switch 38 in the current situation is in an open position so that the lapping compound 20 is able to flow through the sensing system 40 towards the reservoir 30. If the valve or switch 38 is activated (by applying an electric current, a hydraulic pressure, or a pneumatic pressure), the main stream is interrupted and an outlet 39 is opened.

The outlet 39, together with the valve or switch 38 and the electromagnet 36 can be used as follows. If the valve or switch 38 is activated, the main stream is interrupted so that no lapping compound 20 is flowing towards the sensing system 40 and the reservoir 30. If the electromagnet 36 is switched off, the metal chips and particles 22 are released and flushed together with a small amount of the lapping compound 20 through the outlet 39 into a waste tank, for instance. This approach allows the overall system 30 to remove the metal chips and particles 22 which have gathered at the electromagnet 36. If the respective flushing scheme is activated from time to time, the overall system will be free or almost free of metal chips and particles 22.

The sensing system 40 thus can be operated without having to deal with metal chips and particles 22 in the lapping compound 20 flow. The small window at the pipe or hose 32 between the sensing system 40 and the reservoir 30 thus does not show any metal chips and particles 22.

These approaches A1, A2 and A3 can be combined with each other and it is to be mentioned that FIGS. 3A, 3B and 3C are schematic figures only.

Several detection procedures can be used. Details of these procedures will be described in the following sections.

A first embodiment of a sensing system 40 is schematically illustrated in FIG. 4A. One can see a cross-section of a pipe or hose 32, 33. The flow of the lapping compound 20 is perpendicular to the plane of FIG. 4A. The sensing system 40 comprises a transmitter 41 for transmitting an electro-magnetic field EM into the lapping compound 20. This field EM is schematically illustrated in FIG. 4A as a periodic wave signal. There is a receiver 42 for receiving the field EM. This receiver 42 can for instance be located at the opposite side of the pipe or hose 32, 33, as shown in FIG. 4A. It is also possible to use different arrangements of the receiver 42 and/or the transmitter 41. In case of a reflection-based sensing system 40, the transmitter 41 and the receiver 42 are placed at one and the same side of the pipe or hose 32, 33.

The lapping compound 20 in most cases comprises a non-polar, neutral oil serving as a fluid carrier. This fluid carrier does not show any reaction if it is exposed to an electro-magnetic field EM below frequencies of about 10¹⁴ Hz. At higher frequencies (e.g. in the upper visible range up to UV light), the oil used as a fluid carrier might show a characteristic absorption behavior, depending on its molecular structure and chemical bonds. The absorption in the range below frequencies of about 10¹⁴ Hz is largely related to the frequencies of oscillation of the outer electrons of their atoms.

At lower frequencies, e.g. in the infrared (IR) wavelength range (i.e. between 0.75 μm and 1000 μm), the absorption of the atoms and molecules of the fluid carrier contributes to the absorption spectrum. In the near infrared wavelength range the absorption of molecules can be detected.

The chemical bonds within a molecule exhibit characteristic absorption spectra. One refers to these absorbencies as wavenumbers. If a known oil is used as fluid carrier, the absorption behaviour or spectrum of this fluid carrier is known. It can be defined by the specific wavenumbers of this fluid carrier, for instance. The chemical constituents of the fluid carrier (e.g. the hydrocarbons of the synthetic oil) absorb some of the electro-magnetic field EM at reproducible and specific wavenumbers.

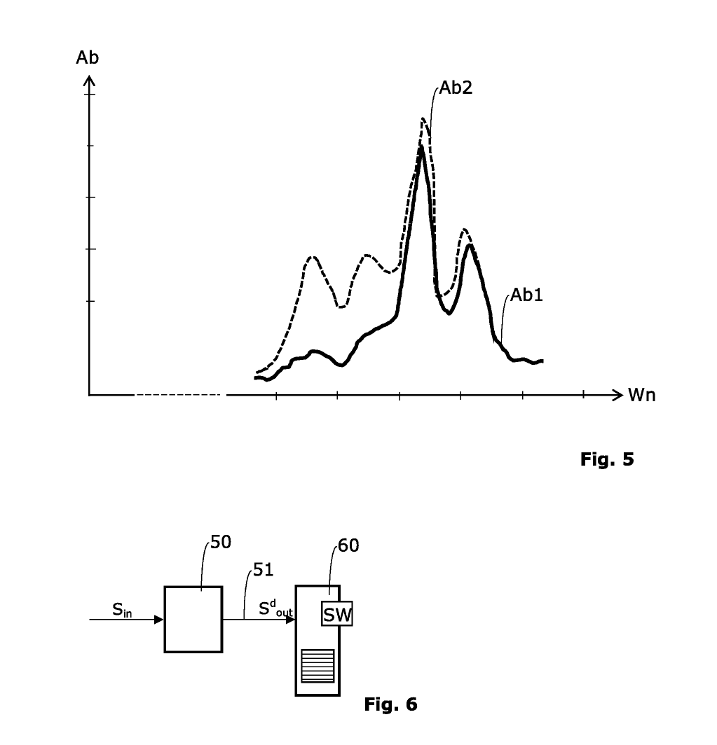

There is, however, an issue which needs to be taken into consideration. If new (hitherto unused oil) is used as fluid carrier, the absorbance of this oil is less pronounced as in oil that contains small amounts of water. The more water the oil contains, the higher the absorbance is. This effect is schematically illustrated in FIG. 5, where the curve Ab1 represents the absorbance of new oil and the curve Ab2 represents the absorbance of oil containing some water and/or small metal particles. However, the wavenumbers Wn which are used to define an oil remain more or less the same, provided the temperature of the oil does not go beyond a temperature during the lapping where the hydrocarbon chains start to disintegrate, and provided the portion of metal particles, carried by the oil, is small.

It has been demonstrated that the abrasive particles 21 do react if exposed to a certain wavelength range of electro-magnetic field EM. This means that the electro-magnetic field EM interacts with the lapping compound 20 and a characteristic response is produced or generated.

Monitoring a certain wavelength range of an electro-magnetic field EM thus is suitable as a direct measurement of the state of the abrasive particles 21.

Whereas the oil, which often serves as a fluid carrier, shows a characteristic absorption spectrum in the IR-range, inorganic molecules do not absorb IR radiation. If IR-radiation is used as an electro-magnetic field EM, one can determine the difference spectrum by subtracting the absorption spectrum of used oil from the absorption spectrum of new oil. The difference spectrum then only contains all other signal elements which are contributed by the abrasive particles 21.

The difference spectrum thus can be used to directly evaluate the abrasive particles 21.

There is a signal processing apparatus 50 which is linked to the transmitter 41 and/or receiver 42, for determining an electric and/or magnetic property/ies of the lapping compound 20. At an output side 51 of the signal processing apparatus 50 a signal Sₒᵤₜ is provided which can be used to trigger the refilling and/or replacing of the lapping compound 20.

Since for the first time it is now possible to determine the current status of the abrasive particles 21 inside the fluid carrier, it is also possible to recondition the lapping compound 20 by adding new abrasive particles 21.

Depending on the energy (amplitude and frequency) of the electro-magnetic field EM a certain amount of energy is reacting or interacting with the abrasive particles 21. To be more precise, the amount of energy of an electro-magnetic field EM is related to its wavelength. The smaller the wavelength, the more energy is carried or conveyed by the field or signal EM.

The reaction of the abrasive particles 21 depends on a number of aspects and the receiver 42 has to be designed so as to be able to detect the corresponding reaction of the abrasive particles 21. In some embodiments, the reaction might comprise reflective and/or transmissive components.

In some embodiments, there is a superposition of two or more physical effects. At radio and microwave frequencies, the electro-magnetic field EM is able to thermally influence the abrasive particles 21 and/or to induce currents. In the infrared range and at higher frequencies (up to the ultraviolet range), electrons inside the abrasive particles 21 can be excited, for instance. At higher frequencies the abrasive particles 21 are facing a certain degree of ionization and eventually the chemical bonds are broken up and the crystal structure is altered.

The lapping compound 20, if loaded with new abrasive particles 21 only, shows a characteristic absorption spectrum that can be detected by the receiver 42 and evaluated by the signal processing apparatus 50.

In at least some embodiments, the sensing system 40 may comprise the elements or building blocks of an infrared spectroscopy. The transmitter 41 in this case contains an IR source (e.g. an light emitting diode or laser) and the receiver 42 contains an infrared (array) detector. The infrared spectroscopy is an advanced technology, which is used for testing degradation and contamination in laboratories, for instance. Up and until now, this technology has not been used in connection with the on-the-fly analyzing of lapping compounds 20.

It is advantageous to feed the lapping compound 20 through a small fluid cell 47 which is designed to provide stable and reproducible conditions for the infrared light penetrating through the cell 47 and the lapping compound 20 contained therein. The fluid cell 47 may comprise elements which are transparent at the wavelength range of the field EM used for the investigation.

A grating or prism might be used at the output side of this cell 47 in order to reflect the impinging light towards the receiver's 42 infrared (array) detector 44. In FIG. 4B, this detector 44 is illustrated by an array of four light sensitive elements 45. In the present embodiment, the receiver 42 further comprises electronic circuitry 46 designed for the pre-processing of signals received.

The sensing system 40 can be based on the principles which have been described in connection with FIGS. 4A and 4B. The set-up, however, depends on the wavelength range and on the lapping compound 20 used.

For the post-processing of the signal(s) Sᵢₙ produced by the sensing system 40, a signal processing apparatus 50 might be employed, as follows.

The signal(s) Sᵢₙ represents the absorbance Ab, as illustrated in FIG. 5. The signal processing apparatus 50 might in some embodiments comprise analog and/or digital circuits for the processing of the signal(s) Sᵢₙ. These circuits can, for instance, be designed in order to be able to detect local maxima and minima of the absorbance Ab and to relate these to the actual wavelength of the field EM. Such a signal processing apparatus 50 is able to detect whether certain peaks of the absorbance Ab are present or not. The signal processing apparatus 50 may further comprise circuits which are designed to be able to determine the amplitude of a peak.

The signal processing apparatus 50 thus is able to detect a characteristic “fingerprint” if fed with an appropriate signal(s) Sᵢₙ. If the signal processing apparatus 50 recognizes the “fingerprint” of a lapping compound 20 which is still in a useful state, then this lapping compound 20 can be used for further lapping operations. If, however, the “fingerprint” of a worn-out lapping compound 20 is recognized, then the signal processing apparatus 50 can issue an output signal Sₒᵤₜ in order to trigger the partial or full replacement of the lapping compound 20.

In at least some embodiments, the output signal Sₒᵤₜ may be used to initiate an automated replacement or refilling of the reservoir 31, for instance. For this purpose, the fluid system 30 may comprise an inlet port with a valve which is controlled by the signal processing apparatus 50 and/or by a computer. The valve is switched open and a pump is activated to pump new lapping compound 20 from a separate tank into the reservoir 31. Before such a refilling process is carried out, some or all of the old lapping compound 20 can be drained from the reservoir 31 using another valve, for instance.

In at least some embodiments a combination of a signal processing apparatus 50 and a computer 60 is used, as illustrated in FIG. 6. In order to be able to communicate with the computer 60, the signal processing apparatus 50 may comprise an analog-to-digital converter so as to transform the analog signal Sᵢₙ into a digital signal S^{d}ₒᵤₜ. If a computer 60 is employed, the post-processing will be carried out digitally. For determining the current status of the lapping compound 20, the computer 60 performs a comparison of the characteristic features of the digital signal S^{d}ₒᵤₜ with characteristic features of a reference specimen. The characteristic features of a reference specimen are stored in a memory of the computer 60 or are retrieved from an external memory (e.g. from a database connected via a network).

The computer 60 may comprise a pattern recognition software SW which will carry out the above-mentioned comparison.

In order to speed up the processing, the signal processing apparatus 50 and/or the computer 60 may be designed so as to mask certain areas of the absorption spectrum. Since, as outlined above, the abrasive particles 21 show characteristic features in a certain wavelength range, the rest of the overall spectrum does not need to be investigated. If the irrelevant areas of the spectrum are electronically or digitally suppressed, for instance, then the post-processing and/or the pattern recognition can focus on the relevant signal portions or pattern sequences only.

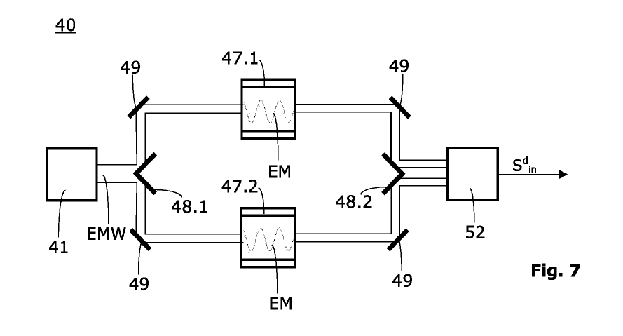

Instead of such an approach where the actual signal or spectrum is compared with the signal or spectrum of a reference specimen, the measurement as such can be carried out as a comparative measurement. A respective embodiment is illustrated in FIG. 7. The sensing system 40 in this case comprises an electro-magnetic transmitter 41 (e.g. an infrared light emitting diode or laser) which emits an electro-magnetic wave EMW (e.g. a light beam) towards a beam splitter 48.1. This beam splitter 48.1 splits the wave EMW into two identical waves which are both reflected by mirrors 49 into a first cell 47.1 and into a second cell 47.2. The first cell 47.1 contains the actual lapping compound 20 whereas the second cell 47.2 contains the original (fresh) lapping compound as reference. The electro-magnetic field EM penetrates through the actual lapping compound 20 and the original (fresh) lapping compound. The two waves EMW are then reflected by mirrors 49 onto a second beam splitter 48.2. The second beam splitter 48.2 redirects the two waves EMW towards a device 52 which for instance comprises a detector which provides for a superposition of the two waves EMW. Due to this superposition, which is carried out in the optical regime, all identical wave features are suppressed. The detector of the device 52 then transforms the remaining signal into a digital signal S^{d}ᵢₙ which is forwarded to a signal processing apparatus 50 and/or computer 60, as illustrated in FIG. 6. In this case, the signal processing apparatus 50 does not require an analog-to-digital converter since the device 52 is already providing a digital signal S^{d}ᵢₙ.

The post-processing in the present case is focused around the analyzing of the digital signal S^{d}ᵢₙ. The computer 60 is designed for comparing the signal S^{d}ᵢₙ with signals of a reference sample taken from memory.

Instead of using an electro-magnetic wave EM, as described above, the sensing system 40 may comprise a transmitter 41 for transmitting an electric signal into the lapping compound 20. The sensing system 40 further comprises a receiver 42 for receiving a signal, based on the electric signal. A signal processing apparatus 50, 60 is linked to said transmitter 41 and/or said receiver 42, for determining the electric and/or magnetic property of the lapping compound 20. Such a sensing system 40 could, for instance, be used in order to measure the electric conductivity of the lapping compound 20.

Likewise, a capacitive sensing arrangement can be used for exposing the lapping compound 20 to a frequency signal and for determining an electro-magnetic response which is caused or triggered by the frequency signal. Such a sensing system 40 is able to determine, based on the response, the electric and/or magnetic property of the lapping compound 20.

If a capacitive sensing arrangement is employed, it is advantageous to design the respective sensing system 40 so that the lapping compound 20 can be exposed to a first frequency signal and a second frequency signal, the first frequency signal having a first frequency the second frequency signal having a second frequency. The first and second frequencies are different so that different properties of the lapping compound 20 can be determined.

As may be recognized by those of ordinary skill in the pertinent art based on the teachings herein, numerous changes and modifications may be made to the above-described and other embodiments without departing from the spirit and/or scope of the invention. Accordingly, this detailed description of embodiments is to be taken in an illustrative as opposed to a limiting sense.

What is claimed is:

1. A metal lapping compound comprising the following components:
an oil portion as fluid carrier,
an abrasive portion, and
a polar portion,
said components defining an ion-containing liquid, and wherein the compound is configured for use in an apparatus for the lapping of gears that comprises a fluid system for supplying the metal lapping compound into an area where, during a lapping operation, a first gear engages with a counterpart, and which apparatus also comprises a sensing system for determining one or more of optic, electric or magnetic properties of the metal lapping compound.

2. The metal lapping compound according to claim 1, wherein the metal lapping compound defines a conductive non-aqueous electrolytic liquid.

3. The metal lapping compound according to claim 1, wherein the polar portion comprises one or more of
ammonia (NH₃);
acetic acid (CH₃CO₂H);
carbonic acid (H₂CO₃); or
phosphoric acid (H₃PO₄).

4. The metal lapping compound according to claim 1, wherein said lapping compound is partially ionized, with a ratio of ionization in a range between about 0.5% and about 20%.

5. The metal lapping compound according to claim 1, wherein said oil portion comprises a low viscosity hydrocarbon.

6. The metal lapping compound according to claim 1, wherein said abrasive portion comprises one or more of
a metal oxide;
a carbide;
boron nitride (CBN);
diamond bort;
garnet; or
bentonite.

7. The metal lapping compound according to claim 1, wherein the lapping compound defines an oil-miscible fluid.

8. The metal lapping compound according to claim 1, wherein the compound is configured for lubricating, lapping, and cooling and is electrolytic.
